(19) United States
(12) Patent Application Publication
(10) Pub. No.: US 2020/0074077 A1
(43) Pub. Date: Mar. 5, 2020

(54) Method for Providing a Security-Critical Software Application on a Computer Unit

(71) Applicant: Build38 GmbH, Munich (DE)

(72) Inventors: Daniel ALBERT, Munich (DE); Frank SCHAFER, Puchheim (DE)

(21) Appl. No.: 16/676,866

(22) Filed: Nov. 7, 2019

Related U.S. Application Data
(63) Continuation of application No. 15/537,608, filed on Jun. 19, 2017.

(30) Foreign Application Priority Data
Dec. 18, 2014 (DE) 102014019090.0

(51) Int. Cl. G06F 21/54; G06F 21/12; G06F 21/14

(52) U.S. Cl. CPC G06F 21/54; G06F 21/125; G06F 2221/0713; G06F 2221/033; G06F 21/14

(57) ABSTRACT

A method is provided for providing a software application on a computer unit. The method comprises the following steps: carrying out an AOT compilation of the software application present in the form of source code to generate assembler code from the source code of the software application; obfuscating the assembler code of the software application; posting the obfuscated assembler code of the software application to a software distribution platform; and downloading the obfuscated assembler code to the computer unit. Further, a corresponding computer unit is provided.

### FIELD OF THE INVENTION

The invention relates to a method for providing a security-critical software application on a computer unit. In particular the invention relates to a method for providing of a security-critical Java application on a mobile end device.

### BACKGROUND OF THE INVENTION

Mobile end devices, for example in the form of smartphones or tablet computers, are increasingly being used to carry out digital transactions, for example the cashless payment at an NFC terminal or the purchase of goods or a service from an online mail order company. When carrying out of such a digital transaction, as a rule a software application implemented on the mobile end device (briefly called “app”) interacts with a terminal or server. Here, frequently a cryptographic algorithm, e.g. an encryption algorithm, is part of the software application implemented on the mobile end device, said application accessing security-critical data, e.g. PINs, passwords, keys etc. In the past, security-critical data have been deposited as a rule on a stand-alone security element of the mobile end device, frequently in the form of a SIM card removable from the mobile end device, to protect these from an attack by unauthorized person.

An approach, which can be used advantageously in particular when carrying out digital transactions with a mobile end device which has no stand-alone security element for securely storing security-critical data, is based on the idea of protecting security-critical software applications and data contained therein from an attacker by means of software measures. One of these software measures consists of making a software application more resistant against attacks by obfuscating or concealing the program code of the software application so that an attacker who has access to this program code can do practically nothing with it. As an example, the Java Code Obfuscator “ProGuard” shall be mentioned here, which is obtainable in the WWW at the address HTTP://developer.android.com/tools/help/proguard.html.

It is the object of the present invention to provide a method for providing a security-critical software application for a computer unit, preferably a mobile end device.

### SUMMARY OF THE INVENTION

According to a first aspect of the invention, a method for providing a software application on a computer unit is made available. The method comprises the following steps: carrying out an AOT compilation of the software application being present in the form of byte code to generate assembler code from the byte code of the software application; obfuscating the assembler code of the software application; posting the obfuscated assembler code of the software application to a software distribution platform; and downloading the obfuscated assembler code to the computer unit.

Preferably the software application is a Java application or a form of an interpreted language executed or interpreted in a virtual machine.

According to preferred embodiments of the invention the software distribution platform is the Google Play Store.

Preferably the computer unit is operated with the operating system Android (version 4.4 or higher).

According to preferred embodiments of the invention, different assembler codes are posted to the software distribution platform for different processor architectures.

According to a second aspect of the invention, a computer unit is provided on which a software application has been provided by a method according to the first aspect of the invention.

According to preferred embodiments of the invention the computer unit is a mobile end device.

As the skilled person will recognize, the hereinabove described preferred embodiments can be advantageously implemented both within the context of the first aspect of the invention, i.e. within the context of the method for providing a software application on a computer unit, and within the context of the second aspect of the invention, i.e. within the context of a such a computer unit.

### BRIEF DESCRIPTION OF THE DRAWINGS

Further features, advantages and objects of the invention will emerge from the following detailed description of several embodiment examples and embodiment alternatives. Reference is made to the drawings, in which there are shown:

FIG. 1 a schematic representation of a communication system with a computer unit in the form of a mobile end device, wherein the present invention is used advantageously,

FIG. 2 a conventional method for providing a security-critical software application on the mobile end device of FIG. 1, and

FIG. 3 a preferred embodiment of a method for providing a security-critical software application on the mobile end device of FIG. 1.

### DETAILED DESCRIPTION OF VARIOUS EMBODIMENTS

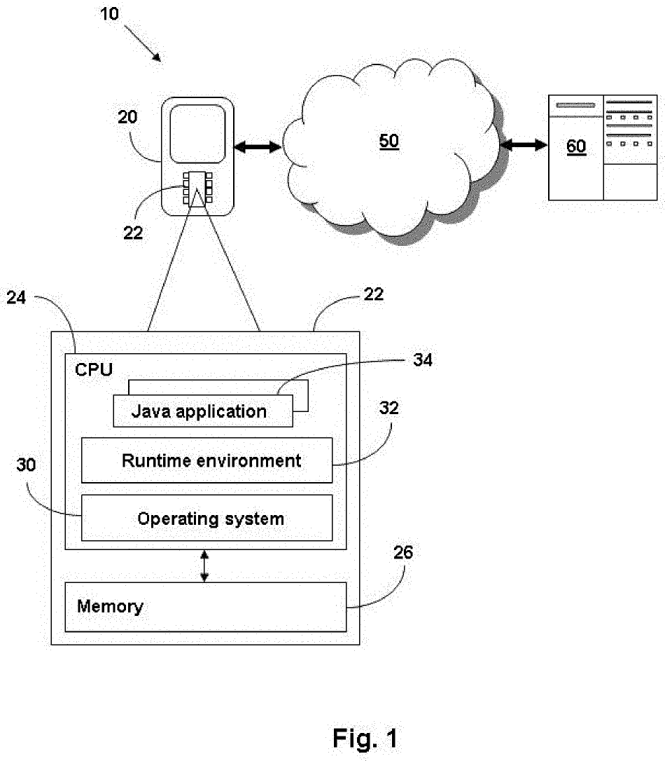

FIG. 1 shows a schematic representation of an exemplary communication system 10, wherein the invention can be used advantageously. The communication system 10 comprises a computer unit 20 in form of a mobile end device, preferably in form of a smartphone or a tablet computer. The mobile end device 20 is configured for communicating with a server or a terminal 60 over a communication channel 50. The communication channel 50 may be, for example, the Internet, a mobile radio network, an NFC channel or the like. The server 60 could be an NFC terminal of a service provider with which a software application, for example the software application 34, can carry out transactions on the mobile end device 20, e.g. a payment transaction, wherein the software application on the mobile end device 20 processes a payment operation.

The mobile end device 20 has a chip 22 with a central processing unit (CPU), for example in the form of a microprocessor 24. As is known, the primary functions of the processor 24 are executing arithmetic and logic functions and reading and writing data elements, as is being defined by a software application running on the processor 24. For clarity's sake, a preferred hardware and software architecture of the processor 24 is shown once again schematically in detail in FIG. 1 outside the mobile end device 20.

The processor 24 is in communication connection with a memory unit 26 which preferably comprises a volatile working memory (RAM), for example for receiving the program code of a software application to be executed by the processor 24. Preferably the memory unit 26 further comprises a non-volatile, preferably re-writable memory, for example to receive in the unenergized state of the mobile end device the program code of a software applications to be executed by the processor 24. Preferably the non-volatile, rewritable memory is a flash memory (flash EEPROM). This may be, for example, a flash memory with a NAND or a NOR architecture. The memory unit 26 can of course also comprise a read only memory (ROM).

As is shown schematically in FIG. 1, at the runtime a runtime environment 32 is implemented in the processor 24 which can access functions close to the hardware which are supplied by an operating system 30. According to preferred embodiments of the invention, the operating system 30 is the Android operating system and the runtime environment 32 is the runtime environment Android Runtime (ART). The runtime environment 32 is implemented such that at least one software application 34 can be executed therein. Preferably the software application 34 is a Java application. As the skilled person recognizes, the program code of the operating system 30, the runtime environment 32 and/or the software application 34 can be deposited in a non-volatile region of the memory unit 26.

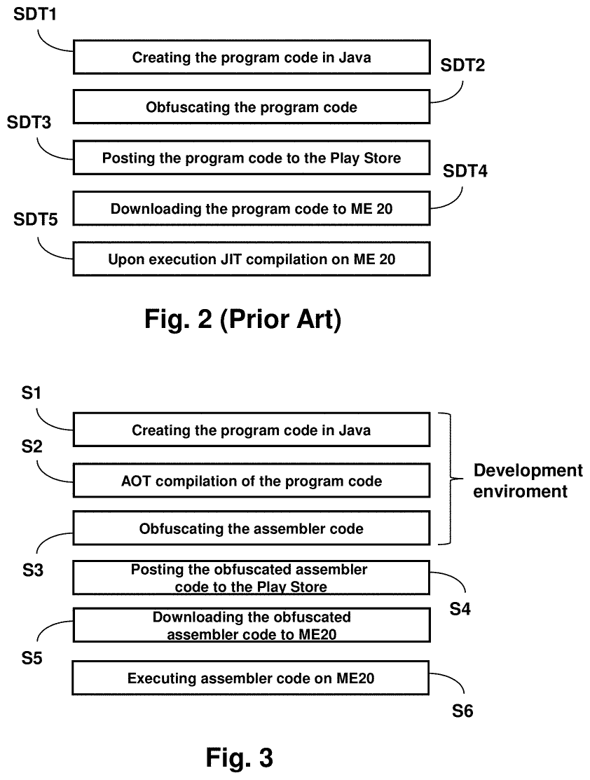

FIG. 2 shows the sequence of a conventional method for providing the software application 34 on the mobile end device 20, wherein the software application 34 is a Java application. Initially, the Java application 34 is created in a first step SDT1 of FIG. 2, i.e. the program or source code of the Java application 34 is written. In the step SDT2 of FIG. 2, the obfuscating measures of the program or source code of the Java application 34 can now be performed. Due to the form in which the program code Java application 34 is present at this time, in step SDT2 of FIG. 2 no strong obfuscating measures can be performed.

After the program code of the Java application 34 has been obfuscated as good as possible in step SDT2, the obfuscated program code of the Java application 34 is posted in step SDT3 of FIG. 2 to a software application distribution platform accessible on the Internet. The software application distribution platform can be provided, for example, on an Internet server, like the server 60 of FIG. 1. Preferably the software application distribution platform is the Google Play Store.

In step SDT4 of FIG. 2, the program code of the Java application 34 can be downloaded from the software application distribution platform to a mobile end device, such as the mobile end device 20 of FIG. 1. As soon as the program code of the Java application 34 has been downloaded to the mobile end device 20, the Java application 34 can be executed during the execution on the mobile end device 20 by effecting as is known a JIT compilation (Just In Time compilation) of the program code of the Java application 34 (see step SDT5 of FIG. 2).

FIG. 3 shows the sequence of a preferred embodiment of a method according to the invention for providing the software application 34 on the mobile end device 20, wherein the software application 34 is preferably a Java application. Initially, in step S1 of FIG. 3 the Java application 34 is created, i.e. the program or source code of the Java application 34 is written. In contrast to the conventional method of FIG. 2, an AOT compilation (Ahead Of Time compilation) of the program code of the Java application 34 is now effected already in step S2 of FIG. 3. Through the step of the AOT compilation in step S2 of FIG. 3, the program code of the Java application 34 is now present in assembler, i.e. as an assembler code (also called native code).

According to the invention, the Java application 34 now present in assembler code is obfuscated in step S3 of FIG. 3. The skilled person will recognize that because the Java application 34 is now present in assembler code, in step S3 of FIG. 3, on account of the differences between Java byte code and assembler code, considerably more effective obfuscating measures can take place than this is possible in step SDT2 of the method of FIG. 2.

As is indicated in FIG. 3, the steps S1 to S3 of FIG. 3 can be carried out in a development environment, for example at the developer of the Java application 34.

After the assembler code of the Java application 34 has been obfuscated in step S3 of FIG. 3, it can be posted in step S4 of FIG. 3 to a software application distribution platform accessible on the Internet. The software application distribution platform can be provided, for example, on an Internet server such as the server 60 of FIG. 1. Preferably the software application distribution platform is the Google Play Store.

In step S5 of FIG. 3, the assembler code of the Java application 34 can be downloaded from the software application distribution platform to a mobile end device, such as the mobile end device 20 of FIG. 1. As soon as the assembler code of the Java application 34 has been downloaded to the mobile end device 20, the Java application 34 can be executed by processing the assembler code of the Java application 34 (see step S6 of FIG. 3). Here, the skilled person will recognize that the holding available of the Java application 34 in the software application distribution platform in the form of assembler code may require that for mobile end devices with different processor architectures and processor versions correspondingly different versions of the Java application 34 must be held available in the form of assembler code.

As already described hereinabove, the skilled person will recognize that due to the differences between Java byte code and assembler code, advantageously considerably more effective obfuscating measures can be used with the inventive method according to FIG. 3 than with the conventional method according to FIG. 2.

1. A method for providing a software application on a computer unit, wherein the method comprises the following steps:
carrying out an Ahead Of Time (AOT) compilation of the software application present in the form of source code to generate assembler code from the source code of the software application;
obfuscating the assembler code of the software application;
posting the obfuscated assembler code of the software application to a software distribution platform, wherein the steps of carrying out the AOT compilation and obfuscating the assembler code are performed in a development environment prior to being made available to any end user device or end user and prior to being made available to the development environment; and
downloading the obfuscated assembler code to the computer unit.

2. The method according to claim 1, wherein the software application is a Java application.

3. The method according to claim 1, wherein the software distribution platform is the Google Play Store.

4. The method according to claim 1, wherein the computer unit is operated with the operating system Android (version 4.4 or higher).

5. The method according to claim 1, wherein different assembler codes for different processor architectures are posted in the software distribution platform.

6. A computer unit comprising:
a processor;
computer readable hardware storage device having stored thereon computer executable code that, when executed by the processor, cause the computing device to perform the following:
carrying out an Ahead Of Time (AOT) compilation of the software application present in the form of source code to generate assembler code from the source code of the software application;
obfuscating the assembler code of the software application, wherein the steps of carrying out the AOT compilation and obfuscating the assembler code are performed in a development environment prior to being made available to any end user device; and
posting the obfuscated assembler code of the software application to a software distribution platform.

7. The computer unit according to claim 6, wherein the computer unit is a mobile end device.
